(19) United States
(12) Patent Application Publication
(10) Pub. No.: US 2026/0365822 A1
(43) Pub. Date: Nov. 19, 2026

(54) RESIN MEMBER FOR ELECTRONIC DEVICE, RESIN COMPOSITION, AND ELECTRONIC DEVICE

(71) Applicant: CANON KABUSHIKI KAISHA, Tokyo (JP)

(72) Inventors: AKIRA YANE, Tokyo (JP); YOSHIHITO OSHIMA, Kanagawa (JP)

(21) Appl. No.: 19/722,212

(22) Filed: Jun. 26, 2026

Related U.S. Application Data
(63) Continuation of application No. PCT/JP2024/044519, filed on Dec. 17, 2024.

(30) Foreign Application Priority Data
Dec. 28, 2023 (JP) 2023-223239

(51) Int. Cl. C08K 3/22

(52) U.S. Cl. CPC C08K 3/22; C08K 2003/2237; C08K 2201/003

(57) ABSTRACT

A resin member for an electronic device includes a matrix resin and dielectric particles dispersed in the matrix resin, wherein dielectric particles are aggregate particles each of which is an aggregate of ferroelectric particles, wherein a particle diameter of the ferroelectric particles is 10 nm or more and 1,000 nm or less, and wherein a particle diameter of the aggregate particles is 1 μm or more and 100 μm or less.

### CROSS-REFERENCE TO RELATED APPLICATIONS

This application is a Continuation of International Patent Application No. PCT/JP2024/044519, filed Dec. 17, 2024, which claims the benefit of Japanese Patent Application No. 2023-223239, filed Dec. 28, 2023, both of which are hereby incorporated by reference herein in their entirety.

### BACKGROUND

### Field of the Technology

The present disclosure relates to a resin member for an electronic device, a resin composition, and an electronic device.

### Description of the Related Art

A resin composition used for a resin member for an electronic device requires high permittivity and moldability. Japanese Patent Laid-Open No. 2021-66831 describes a resin composition obtained by containing barium titanate, which is a ferroelectric having a particle diameter of about several micrometers and high sphericity, in a polycarbonate resin.

In a case where a dielectric having high permittivity, such as a ferroelectric, a paraelectric having a relative permittivity of 10 or more, or the like, is dispersed in a matrix resin, there is an issue that dielectric particles near the surface are polarized due to friction or the like, whereby the surface of a resin member for an electronic device is charged, and dust is likely to be attached to the resin member. Particularly, in a case where relatively large particles having a particle diameter of 1 μm or more are used, the amount of charge on the surface is likely to increase. Thus, if the relatively large particles are used for a resin member for an electronic device, there is an issue that dust is likely to be attached to the resin member.

### SUMMARY

The present disclosure is directed to providing a resin member for an electronic device excellent in electrical characteristics.

According to an aspect of the present disclosure, a resin member for an electronic device, a volume of the resin member being 1,000 mm³ or more, includes a matrix resin and dielectric particles dispersed in the matrix resin, wherein the dielectric particles are aggregate particles each of which is an aggregate of ferroelectric particles, wherein a particle diameter of the ferroelectric particles is 10 nm or more and 1,000 nm or less, wherein a particle diameter of the aggregate particles is 1 μm or more and 100 μm or less, and wherein a contained amount of the dielectric particles is 0.1 mass % or more and 10 mass % or less.

According to another aspect of the present disclosure, a resin member for an electronic device, a volume of the resin member being 1,000 mm³ or more, includes a matrix resin containing a polar polymer and/or a crystalline polymer and dielectric particles dispersed in the matrix resin, wherein the dielectric particles are aggregate particles each of which is an aggregate of paraelectric particles having a relative permittivity of 10 or more, wherein a particle diameter of the paraelectric particles is 10 nm or more and 1,000 nm or less, and wherein a particle diameter of the aggregate particles is 1 μm or more and 100 μm or less.

According to yet another aspect of the present disclosure, a resin composition includes a matrix resin and dielectric particles dispersed in the matrix resin, wherein the dielectric particles are aggregate particles each of which is an aggregate of ferroelectric particles, wherein a particle diameter of the ferroelectric particles is 10 nm or more and 1,000 nm or less, wherein a particle diameter of the aggregate particles is 1 μm or more and 100 μm or less, and wherein the matrix resin contains polyester and carbodiimide.

According to yet another aspect of the present disclosure, a resin composition includes a matrix resin and dielectric particles dispersed in the matrix resin, wherein the dielectric particles are aggregate particles each of which is an aggregate of paraelectric particles having a relative permittivity of 10 or more, wherein a particle diameter of the paraelectric particles is 10 nm or more and 1,000 nm or less, wherein a particle diameter of the aggregate particles is 1 μm or more and 100 μm or less, and wherein the matrix resin contains polyester and carbodiimide.

Features of the present disclosure will become apparent from the following description of embodiments with reference to the attached drawings.

### BRIEF DESCRIPTION OF THE DRAWINGS

FIG. 1A is a conceptual diagram illustrating a state in which dielectric particles are dispersed in a matrix resin.

FIG. 1B is a conceptual diagram illustrating a state in which dielectric particles are dispersed in a matrix resin.

FIG. 2A is a conceptual diagram illustrating a state in which primary particles of the dielectrics in FIG. 1A are polarized.

FIG. 2B is a conceptual diagram illustrating a state in which primary particles of the dielectrics in FIG. 1B are polarized.

FIG. 3 is a schematic diagram illustrating an electronic device according to the present embodiment.

### DESCRIPTION OF THE EMBODIMENTS

Embodiments for carrying out the present disclosure will be described in detail below. The following embodiments are illustrative examples for describing the present disclosure, and the present disclosure is not limited to the following description.

### <<Resin Member for Electronic Device>>

A first resin member for an electronic device according to the present embodiment is a resin member including a matrix resin and dielectric particles dispersed in the matrix resin. The dielectric particles are aggregate particles each of which is an aggregate of ferroelectric particles. The particle diameter of the ferroelectric particles is 10 nm or more and 1,000 nm or less. The particle diameter of the aggregate particles is 1 μm or more and 100 μm or less.

A second resin member for an electronic device according to the present embodiment is a resin member including a matrix resin and dielectric particles dispersed in the matrix resin. The dielectric particles are aggregate particles each of which is an aggregate of paraelectric particles having a relative permittivity of 10 or more. The particle diameter of the paraelectric particles is 10 nm or more and 1,000 nm or less. The particle diameter of the aggregate particles is 1 μm or more and 100 μm or less.

When friction occurs between a resin member for an electronic device and another member, these members exchange electrons. The member that transfers the electron is positively charged, the member that receives the electron is negatively charged, and each member enters a charged state. A ferroelectric and a paraelectric having a relative permittivity of 10 or more (hereinafter, the ferroelectric and the paraelectric will occasionally be referred to collectively as a “dielectric”), particularly the ferroelectric, has a strong property of being polarized inside the dielectric and holding a charge. Thus, if the dielectric is included in the material of the resin member for an electronic device, the amount of charge is great, and dust is likely to be attached to the resin member.

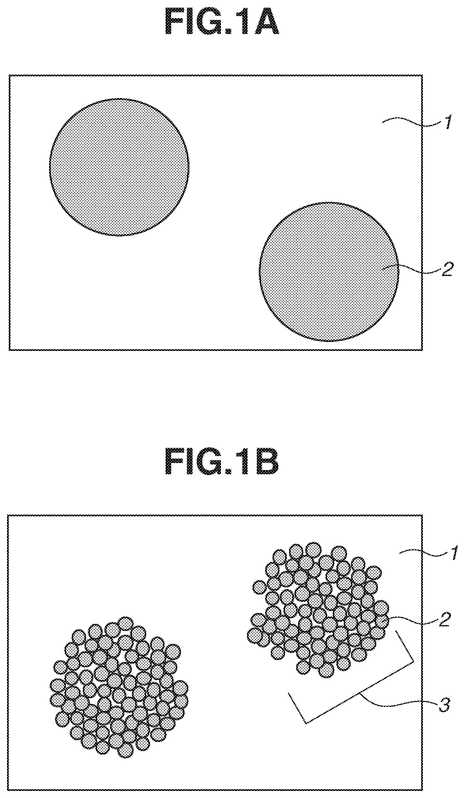

FIGS. 1A and 1B are conceptual diagrams illustrating the states in which dielectric particles are dispersed in a matrix resin. FIG. 1A illustrates the state in which primary particles of a dielectric having a relatively large particle diameter are dispersed. FIG. 1B illustrates the state in which primary particles of a dielectric having a relatively small particle diameter aggregate and are dispersed as aggregate particles (secondary particles) having almost the same particle diameter as that of the particles in FIG. 1A. FIGS. 1A and 1B illustrate a matrix resin 1, primary particles 2 of a dielectric, and aggregate particles 3.

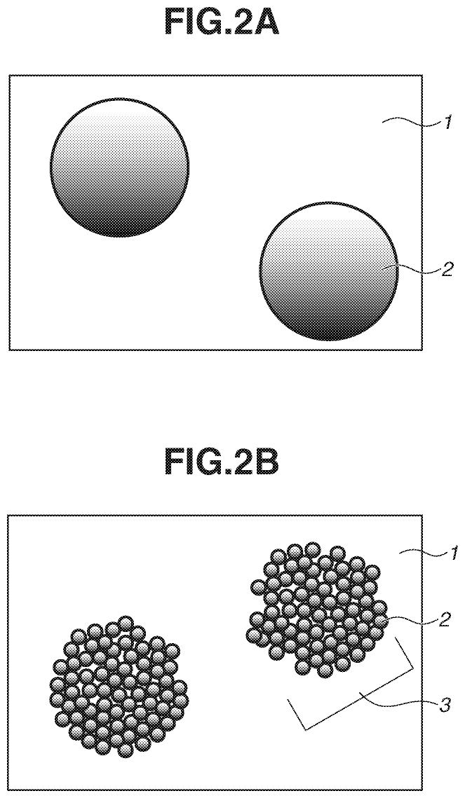

FIGS. 2A and 2B are conceptual diagrams illustrating the states in which the primary particles 2 of the dielectric in FIGS. 1A and 1B are polarized, respectively. FIG. 2A illustrates the state in which the primary particles 2 of the dielectric in FIG. 1A are polarized. FIG. 2B illustrates the state in which the primary particles 2 of the dielectric in FIG. 1B are polarized. In FIGS. 2A and 2B, the charged states of the primary particles 2 of the dielectric are indicated by light and shade.

If the particle diameter of the primary particles 2 of the dielectric is relatively large as illustrated in FIG. 1A, the amount of charge per particle is great in proportion to the volume of the particles. Then, the primary particles 2 of the dielectric are dispersed in the matrix resin 1 and present near the surface of the resin member for an electronic device, whereby the amount of charge on the surface of the resin member for an electronic device is great, and the amount of attached dust is great.

In contrast, in the present embodiment, as dielectric particles in a resin member for an electronic device, the primary particles 2 of the dielectric having a relatively small particle diameter as illustrated in FIG. 1B aggregate and form the aggregate particles 3. In this case, the amount of charge on the surface of the resin member for an electronic device is smaller than that in a case of the primary particles 2 of the dielectric having almost the same particle diameter as the particle diameter of the aggregate particles 3, and the amount of attached dust is reduced.

The reason for this can be considered as follows. That is, in the case of the primary particles having a relatively large particle diameter as illustrated in FIG. 1A, polarization occurs over the entirety of each particle as illustrated in FIG. 2A, and thus, the amount of charge is great. In a case where, on the other hand, the primary particles having a relatively small particle diameter aggregate and form the aggregate particles having a large particle diameter as illustrated in FIG. 1B, this results in an aggregation of primary particles polarized inside the individual primary particles as illustrated in FIG. 2B. Consequently, only primary particles exposed to the surface of the resin member for an electronic device influence the amount of charge on the surface. It is considered that, as a result, in the present embodiment, the amount of attached dust is reduced. The charging property is one of the electrical characteristics of the resin member and can be controlled based on the form of the dielectric particles.

The dielectric particles are in an aggregated state, and the aggregate particles have a particle diameter greater than or equal to a certain diameter, whereby the area of the interface between the matrix resin and the dielectric particles is not excessively large, and an increase in the viscosity is maintained to be small. This causes even the moldability to be maintained in an excellent state.

Further, the aggregate particles are advantageous in an electromagnetic shielding property. As an indicator related to the electromagnetic shielding property, there is a parameter termed a dielectric dissipation factor. In the case of FIG. 1B, the dielectric dissipation factor is higher than that in the case of FIG. 1A. The dielectric dissipation factor is a parameter indicating, when a radio wave resonates with a dielectric, the amount of the radio wave lost by being converted into heat. The greater the dielectric dissipation factor is, the more excellent the electromagnetic shielding property is. The electromagnetic shielding property is one of the electrical characteristics of the resin member and can be controlled based on the form of the dielectric particles.

<<Method for Manufacturing Resin Member for Electronic Device>>

### <Resin Composition>

First, a description is given of a resin composition that is used to manufacture a resin member for an electronic device according to the present embodiment. The resin composition according to the present embodiment includes a matrix resin and dielectric particles. Further, the resin composition according to the present embodiment may include an elastomer, and may include filler particles, other than the dielectric particles, having an inorganic material as a main component.

### [Matrix Resin]

The matrix resin may only need to be a polymer having a repeating structure. Examples of the matrix resin include a thermoplastic resin and a thermosetting resin. As the matrix resin, the thermoplastic resin is desirable.

Examples of the thermoplastic resin include polyethylene, polystyrene, polypropylene, polyethylene terephthalate, polybutylene terephthalate, polyamide, polyether sulfone, an acrylonitrile-styrene resin, an acrylonitrile-butadiene-styrene resin, an acrylic resin, polycarbonate, polyetherimide, polyether ether ketone, polyacetal, polyphenylene oxide, polyphenylene sulfide, and the like.

Examples of the thermosetting resin include an epoxy resin, an unsaturated polyester resin, a vinyl ester resin, and the like.

It is desirable that the matrix resin be a polar polymer. The polar polymer is a resin in which polarization is present in the molecules. The polar polymer is oriented in a direction opposite to the polarization of the dielectric particles and can ease charging.

For example, the polar polymer refers to a polymer having, in a main chain, a polar group such as an amide group, an imide group, a carbonyl group (a ketone group), an ester bond, or the like. The polar polymer is a resin generally termed a general-purpose engineering plastic or a super engineering plastic and is used for an application requiring higher physical properties in heat resistance, strength, and the like than a general-purpose resin, such as polyethylene or polypropylene. If improvements in mechanical property values is realized, it is possible to make a molded product thin and light. Thus, further improvements in the physical properties of the polar polymer are expected.

Specific examples of the polar polymer as the polymer including the amide group include polyamide, polyamide-imide, and the like. Examples of the polar polymer as the polymer including the imide group include polyimide, polyamide-imide, polyetherimide, and the like. Examples of the polar polymer as the polymer including the carbonyl group (the ketone group) include polyetherketone, polyether ether ketone, and the like. Examples of the polar polymer as the polymer including the ester bond include polyarylate, polycarbonate, polyester, and the like. Examples of the polyester include polyethylene terephthalate, polybutylene terephthalate, polyethylene naphthalate, polybutylene naphthalate, and the like.

It is desirable to use a crystalline polymer as the matrix resin among the thermoplastic resins. In the crystalline polymer, the molecules are oriented in a fixed direction, and thus, polarization in the molecules is greater than in a non-crystalline state, which can relax the polarization of the dielectric particles. The crystalline polymer is advantageous in that the crystalline polymer is excellent in hardness, elasticity, and stiffness compared to a non-crystalline polymer. Among the above polar polymers, examples of the crystalline polymer include the polyamide, the polyetherketone, the polyether ether ketone, the polyethylene terephthalate, the polybutylene terephthalate, the polyethylene naphthalate, the polybutylene naphthalate, and the like. Among the polyesters, the polyarylate and the polycarbonate are non-crystalline polymers. As the polar polymer, the polyester is desirable, and the polyethylene terephthalate is more desirable. The polyethylene terephthalate is both a polar polymer and a crystalline polymer, and the molecules are likely to be oriented, which can relax the polarization of the dielectric particles more effectively. The CO₂ emission in the production of the polyethylene terephthalate is smaller than the CO₂ emission in the production of the polycarbonate. Thus, the use of the polyethylene terephthalate can contribute to reducing CO₂ emissions. For example, the crystallinity of the crystalline polymer is 1% to 50%. It is desirable that the crystallinity of the crystalline polymer be 1% to 40%. The crystallinity can be controlled by molding conditions (temperature and pressure).

Alternatively, the matrix resin may be a polar polymer cross-linked using a cross-linking agent. Examples of the cross-linking agent include compounds that perform a cross-link reaction by heat, such as a carbodiimide cross-linking agent, an oxazoline cross-linking agent, an epoxy cross-linking agent, an isocyanate cross-linking agent, and the like. For example, the polar polymer may be a recycled polymer obtained by collecting a used polymer having a decreased molecular weight, re-cross-linking the used polymer using the cross-linking agent, and increasing the molecular weight. As the used polymer and the recycled polymer, polyethylene terephthalate, which is produced and used in large amounts, is desirable.

The carbodiimide cross-linking agent according to the present embodiment refers to a compound including at least one carbodiimide group in a molecule, and for example, can be manufactured by a decarboxylation reaction caused by heating an organic isocyanate in the presence of an appropriate catalyst. The carbodiimide group is represented as (—N═C═N—). In the matrix resin using the carbodiimide cross-linking agent, a carbodiimide group derived from the carbodiimide cross-linking agent is present as a part of a macromolecule.

Examples of the carbodiimide cross-linking agent include mono- or dicarbodiimide compounds such as diphenylcarbodiimide, dicyclohexylcarbodiimide, di-2,6-dimethylphenylcarbodiimide, diisopropylcarbodiimide, dioctyldecylcarbodiimide, di-o-toluylcarbodiimide, di-p-toluylcarbodiimide, di-p-nitrophenylcarbodiimide, di-p-aminophenylcarbodiimide, di-p-hydroxyphenylcarbodiimide, di-p-chlorophenylcarbodiimide, di-o-chlorophenylcarbodiimide, di-3,4-dichlorophenylcarbodiimide, di-2,5-dichlorophenylcarbodiimide, p-phenylene-bis-o-toluylcarbodiimide, p-phenylene-bis-dicyclohexylcarbodiimide, p-phenylene-bis-di-p-chlorophenylcarbodiimide, 2,6,2′,6′-tetraisopropyldiphenylcarbodiimide, hexamethylene-bis-cyclohexylcarbodiimide, ethylene-bis-diphenylcarbodiimide, ethylene-bis-di-cyclohexylcarbodiimide, N,N′-di-o-tolylcarbodiimide, N,N′-diphenylcarbodiimide, N,N′-dioctyldecylcarbodiimide, N,N′-di-2,6-dimethylphenylcarbodiimide, N-tolyl-N′-cyclohexylcarbodiimide, N,N′-di-2,6-diisopropylphenylcarbodiimide, N,N′-di-2,6-di-tert-butylphenylcarbodiimide, N-toluyl-N′-phenylcarbodiimide, N,N′-di-p-nitrophenylcarbodiimide, N,N′-di-p-aminophenylcarbodiimide, N,N′-di-p-hydroxyphenylcarbodiimide, N,N′-di-cyclohexylcarbodiimide, N,N′-di-p-toluylcarbodiimide, N,N′-benzylcarbodiimide, N-octadecyl-N′-phenylcarbodiimide, N-benzyl-N′-phenylcarbodiimide, N-octadecyl-N′-tolylcarbodiimide, N-cyclohexyl-N′-tolylcarbodiimide, N-phenyl-N′-tolylcarbodiimide, N-benzyl-N′-tolylcarbodiimide, N,N′-di-o-ethylphenylcarbodiimide, N,N′-di-p-ethylphenylcarbodiimide, N,N′-di-o-isopropylphenylcarbodiimide, N,N′-di-p-isopropylphenylcarbodiimide, N,N′-di-o-isobutylphenylcarbodiimide, N,N′-di-p-isobutylphenylcarbodiimide, N,N′-di-2,6-diethylphenylcarbodiimide, N,N′-di-2-ethyl-6-isopropylphenylcarbodiimide, N,N′-di-2-isobutyl-6-isopropylphenylcarbodiimide, N,N′-di-2,4,6-trimethylphenylcarbodiimide, N,N′-di-2,4,6-triisopropylphenylcarbodiimide, N,N′-di-2,4,6-triisobutylphenylcarbodiimide, and the like; polycarbodiimides such as poly(1,6-hexamethylenecarbodiimide), poly(4,4′-methylenebiscyclohexylcarbodiimide), poly(1,3-cyclohexylenecarbodiimide), poly(1,4-cyclohexylenecarbodiimide), poly(4,4′-diphenylmethanecarbodiimide), poly(3,3′-dimethyl-4,4′-diphenylmethanecarbodiimide), poly(naphthylenecarbodiimide), poly(p-phenylenecarbodiimide), poly(m-phenylenecarbodiimide), poly(tolylcarbodiimide), poly(diisopropylcarbodiimide), poly(methyl-diisopropylphenylenecarbodiimide), poly(triethylphenylenecarbodiimide), poly(triisopropylphenylenecarbodiimide), and the like.

The oxazoline cross-linking agent according to the present embodiment refers to a compound including an oxazoline group in a molecule. Particularly, a polymer synthesized using a monomer including an oxazoline compound as at least one of the raw material monomers of the polymer is desirable. Examples of the oxazoline compounds include a 2-oxazoline compound, a 3-oxazoline compound, and a 4-oxazoline compound, and any of these may be used. Particularly, the 2-oxazoline compound has high reactivity and has also been put to practical industrial use. Examples of the oxazoline compounds include 2-vinyl-2-oxazoline, 5-methyl-2-vinyl-2-oxazoline, 4,4-oxazoline, 4,4-dimethyl-2-vinyl-5,6-dihydro-4H-1,-oxazine, 4,4,6-trimethyl-2-vinyl-5,6-dihydro-4H-1,3-oxazine, 2-isopropenyl-2-oxazoline, 4,4-dimethyl-2-isopropenyl-2-oxazoline, 4-acryloyl-oxymethyl-2,4-dimethyl-2-oxazoline, 4-methacryloyloxymethyl-2,4-dimethyl-2-oxazoline, 4-methacryloyloxymethy-2-phenyl-4-methyl-2-oxazoline, 2-(4-vinylphenyl)-4,4-dimethyl-2-oxazoline, 4-ethyl-4-hydroxymethyl-2-isopropenyl-2-oxazoline, 4-ethyl-4-carboethoxymethyl-2-isopropenyl-2-oxazoline, and the like. The present embodiment, however, is not limited to these examples.

As the epoxy cross-linking agent according to the present embodiment, for example, a glycidyl ether compound, a glycidyl ester compound, a glycidyl amine compound, a glycidyl imide compound, an alicyclic epoxy compound, or the like can be desirably used.

Examples of the glycidyl ether compounds include butyl glycidyl ether, stearyl glycidyl ether, allyl glycidyl ether, phenyl glycidyl ether, o-phenyl phenyl glycidyl ether, ethylene oxide lauryl alcohol glycidyl ether, ethylene oxide phenol glycidyl ether, ethylene glycol diglycidyl ether, polyethylene glycol diglycidyl ether, propylene glycol diglycidyl ether, polypropylene glycol diglycidyl ether, neopentyl glycol diglycidyl ether, polytetramethylene glycol diglycidyl ether, cyclohexane dimethanol diglycidyl ether, glycerol triglycidyl ether, trimethylol propane triglycidyl ether, pentaerythritol polyglycidyl ether, and epoxy resins such as bisphenol A diglycidyl ether type epoxy resins, bisphenol F diglycidyl ether type epoxy resins, and bisphenol S diglycidyl ether type epoxy resins, which are obtained by condensation reactions between bisphenols such as 2,2-bis-(4-hydroxyphenyl)propane, 2,2-bis-(4-hydroxyphenyl)methane, and bis(4-hydroxyphenyl)sulfone with epichlorohydrin. Among these, a bisphenol A diglycidyl ether type epoxy resin is desirable.

Examples of glycidyl ester compounds include benzoic acid glycidyl ester, p-toluic acid glycidyl ester, cyclohexanecarboxylic acid glycidyl ester, stearic acid glycidyl ester, lauric acid glycidyl ester, palmitic acid glycidyl ester, versatic acid glycidyl ester, oleic acid glycidyl ester, linoleic acid glycidyl ester, linolenic acid glycidyl ester, terephthalic acid diglycidyl ester, isophthalic acid diglycidyl ester, phthalic acid diglycidyl ester, naphthalenedicarboxylic acid diglycidyl ester, dibenzoic acid diglycidyl ester, methylterephthalic acid diglycidyl ester, hexahydrophthalic acid diglycidyl ester, tetrahydrophthalic acid diglycidyl ester, cyclohexanedicarboxylic acid diglycidyl ester, adipic acid diglycidyl ester, succinic acid diglycidyl ester, sebacic acid diglycidyl ester, dodecanedioic acid diglycidyl ester, octadecanedioic acid diglycidyl ester, trimellitic acid triglycidyl ester, pyromellitic acid tetraglycidyl ester, and the like. Among these, benzoic acid glycidyl ester and versatic acid glycidyl ester are desirable.

Examples of glycidyl amine compounds include tetraglycidylaminodiphenylmethane, triglycidyl-para-aminophenol, triglycidyl-meta-aminophenol, diglycidyl aniline, diglycidyl toluidine, tetraglycidyl-meta-xylylenediamine, diglycidyl tribromoaniline, tetraglycidylbis(aminomethyl)cyclohexane, triglycidyl cyanurate, triglycidyl isocyanurate, and the like. Examples of glycidyl imide compounds include N-glycidylphthalimide, N-glycidyl-4-methylphthalimide, N-glycidyl-4,5-dimethylphthalimide, N-glycidyl-3-methylphthalimide, N-glycidyl-3,6-dimethylphthalimide, N-glycidyl-4-ethoxyphthalimide, N-glycidyl-4-chlorophthalimide, N-glycidyl-4,5-dichlorophthalimide, N-glycidyl-3,4,5,6-tetrabromophthalimide, N-glycidyl-4-n-butyl-5-bromophthalimide, N-glycidylsuccinimide, N-glycidylhexahydrophthalimide, N-glycidyl-1,2,3,6-tetrahydrophthalimide, N-glycidylmaleimide, N-glycidyl-α,β-dimethylsuccinimide, N-glycidyl-α-ethylsuccinimide, N-glycidyl-α-propylsuccinimide, N-glycidylbenzamide, N-glycidyl-α-methylbenzamide, N-glycidylnaphthamide, N-glycidylstearamide, and the like.

Among these, the N-glycidylphthalimide is desirable.

Examples of alicyclic epoxy compounds include 3,4-epoxycyclohexylmethyl-3,4-epoxycyclohexylcarboxylate, bis(3,4-epoxycyclohexylmethyl)adipate, vinylcyclohexenediepoxide, N-methyl-4,5-epoxycyclohexane-1,2-dicarboxylic acid imide, N-ethyl-4,5-epoxycyclohexane-1,2-dicarboxylic acid imide, N-phenyl-4,5-epoxycyclohexane-1,2-dicarboxylic acid imide, N-naphthyl-4,5-epoxycyclohexane-1,2-dicarboxylic acid imide, N-tolyl-3-methyl-4,5-epoxycyclohexane-1,2-dicarboxylic acid imide, and the like.

As other epoxy compounds, epoxy-modified fatty acid glycerides such as epoxidized soybean oil, epoxidized linseed oil, epoxidized whale oil, phenol novolac epoxy resins, cresol novolac epoxy resins, or the like can be used.

The isocyanate cross-linking agent used in the present embodiment is not particularly limited as long as the isocyanate cross-linking agent includes an isocyanate group as a functional group in this compound. A known polyisocyanate cross-linking agent can be used. Specifically, a generally used water-dispersible polyisocyanate cross-linking agent can be used. The water-dispersible polyisocyanate cross-linking agent is obtained by introducing a hydrophilic group into a polyisocyanate polymer. When the water-dispersible polyisocyanate cross-linking agent is added to water and agitated, the water-dispersible polyisocyanate cross-linking agent can be dispersed as microparticles into water.

Examples of the polyisocyanate constituting the water-dispersible polyisocyanate include aliphatic isocyanates such as hexamethylene diisocyanate, trimethylhexamethylene diisocyanate, tetramethylene diisocyanate, pentamethylene diisocyanate, lysine diisocyanate, dimer acid diisocyanate, and the like; aromatic polyisocyanates such as tolylene diisocyanate, xylylene diisocyanate, diphenylmethane diisocyanate, tetramethylxylylene diisocyanate, 1,5-naphthalene diisocyanate, 1,4-naphthalene diisocyanate, 4,4′-toluidine diisocyanate, 4,4′-diphenyl ether diisocyanate, (m- or p-)phenylene diisocyanate, 4,4′-biphenylene diisocyanate, 3,3′-biphenylene diisocyanate, bis(4-isocyanatophenyl)sulfone, isopropylidenebis(4-phenylisocyanate), and the like; and alicyclic diisocyanate compounds such as hydrogenated xylylene diisocyanate, isophorone diisocyanate, 4,4′-methylenebis(cyclohexylisocyanate), methylcyclohexane-2,4-(or -2,6-)diisocyanate, 1,3-(or 1,4-)di(isocyanatomethyl)cyclohexane, 1,4-cyclohexane diisocyanate, 1,3-cyclopentane diisocyanate, 1,2-cyclohexane diisocyanate, and the like. As such a polyisocyanate compound, a polyisocyanate compound having an isocyanurate structure, a urethane structure, a biuret structure, an allophanate structure, a uretdione structure, a trimeric structure, or the like can also be used. A so-called blocked isocyanate obtained by blocking an isocyanate group with an active hydrogen group may be used.

It is desirable that the matrix resin be formed of one of these polar polymers or a mixture of these polar polymers.

### [Dielectric (Ferroelectric and Paraelectric Having Relative Permittivity of 10 or More)]

The ferroelectric is not particularly limited as long as the ferroelectric exhibits ferroelectricity. The ferroelectric typically has a perovskite structure, but may be a tetragonal crystal or a rhombohedral crystal (a rhombohedral). Examples of the ferroelectric include titanate compounds such as barium titanate, bismuth titanate, lead titanate, lead zirconate titanate, lanthanum lead zirconate titanate, and the like, bismuth ferrate (bismuth ferrite), strontium bismuth tantalate, strontium bismuth niobate, and the like. Alternatively, the titanium of each titanate compound may be replaced by hafnium (Hf) or zirconium (Zr) in the same group, or the barium (Ba) of the barium titanate may be replaced by calcium (Ca) or strontium (Sr) in the same group. It is also known that hafnium oxide having an orthorhombic crystal structure exhibits ferroelectricity. Among these, the titanate compounds are desirable, and the barium titanate is further desirable due to high relative permittivity. Each of these ferroelectrics may be used alone, or two or more of the ferroelectrics may be used in an appropriate mixture.

The ferroelectric particles may have a core-shell structure including two phases, namely a core portion composed of a crystal having high permittivity and a shell portion surrounding the core portion and having relatively low permittivity. For example, the ferroelectric particles may have a core-shell structure including a core portion composed of a crystal of barium titanate and a shell portion containing a rare-earth element such as dysprosium (Dy), holmium (Ho), or the like.

Examples of paraelectrics having a relative permittivity of 10 or more include titanium oxide (titania), zirconium oxide (zirconia), hafnium oxide (hafnia), yttrium oxide (yttria), lanthanum oxide, cerium oxide (ceria), tantalum oxide, niobium oxide, zinc titanate, magnesium titanate, strontium titanate, calcium titanate, calcium zirconate, and the like. It is desirable that the relative permittivity of the paraelectric be 50 or more. It is more desirable that the relative permittivity of the paraelectric be 100 or more. It is further desirable that the relative permittivity of the paraelectric be 500 or more. It is even further desirable that the relative permittivity of the paraelectric be 1,000 or more.

It is desirable that the particle diameter (the primary particle diameter) of the ferroelectric particles (the primary particles) and the paraelectric particles (the primary particles) having a relative permittivity of 10 or more be 10 nm or more and 1,000 nm or less. In a case where the particle diameter of the primary particles of the dielectric is larger than 1,000 nm, the amount of charge in the particles is great, and the amount of charge on the surface of the resin member for an electronic device is great. Thus, it is desirable that the particle diameter of the primary particles of the dielectric be 1,000 nm or less. In a case where the particle diameter of the primary particles of the dielectric is 300 nm or less, the amount of charge decreases, and thus, the attachment of dust is further prevented, which is more desirable. In a case where the particle diameter of the primary particles of the dielectric is smaller than 10 nm, the cohesion among the particles is great. Then, when the aggregate particles are formed, the particles exchange charges, the amount of charge is great in the entirety of the aggregate particles, and the amount of charge on the surface of the resin member for an electronic device is great. Thus, it is desirable that the particle diameter of the primary particles of the dielectric be 10 nm or more. In a case where the particle diameter of the primary particles of the dielectric is 50 nm or more, the cohesion among the particles decreases, and the controllability of the particle diameter increases, which is more desirable.

It is desirable that the dielectric be in an aggregated state. Further, it is desirable that the particle diameter (the secondary particle diameter) of the aggregate particles (the secondary particles) be 1 μm or more and 100 μm or less. In a case where the particle diameter of the aggregate particles is less than 1 μm, the surface area of the aggregate particles is large, the area of the interface with the matrix resin increases, the melt viscosity increases, and excellent moldability cannot be obtained. Thus, it is desirable that the particle diameter of the aggregate particles be 1 μm or more. In a case where the particle diameter of the aggregate particles is 5 μm or more, further excellent fluidity is obtained, which is more desirable. In a case where the particle diameter of the aggregate particles is 5 μm or more, charges interfere with each other in a complex manner among the dielectric particles in the aggregate particles. Thus, the dielectric dissipation factor is high, and the electromagnetic shielding property further improves, which is more desirable. If, on the other hand, the particle diameter of the aggregate particles is greater than 100 μm, the surface property deteriorates under the influence of the aggregate particles, and thus excellent moldability cannot be obtained. Thus, it is desirable that the particle diameter of the aggregate particles be 100 μm or less. In a case where the particle diameter of the aggregate particles is 50 μm or less, the surface property is further excellent, which is more desirable.

Although the shape of the aggregate particles is not particularly limited, it is desirable that the shape of the aggregate particles be a scale-like shape. In a case where the shape of the aggregate particles is a scale-like shape, the aggregate particles function as a crystal nucleus agent or a crystallization promoter, and the crystallization of the matrix resin is promoted on the periphery of the aggregate particles. As a result, a portion where the crystallization is promoted and a portion where the crystallization is not promoted are present in the resin member for an electronic device. The portion where the crystallization is promoted and the portion where the crystallization is not promoted are different in elastic modulus from each other. Thus, if a small amount of aggregate particles is unevenly present, and when a vibration is generated, the resin member deforms unevenly, energy loss due to shear friction occurs, and vibration damping properties improve.

It is desirable that the aspect ratio of the aggregate particles be 3 or more and 20 or less. In a case where the aspect ratio of the aggregate particles is less than 3, the aggregate particles may be likely to be exposed to the surface when molding is performed, and thus the amount of charge on the surface may be great. Further, it is desirable that the aspect ratio of the aggregate particles be 5 or more because the amount of charge on the surface decreases. If, on the other hand, the aspect ratio of the aggregate particles is more than 20, the surface property may deteriorate under the influence of the aggregate particles, and excellent moldability may not be able to be obtained. Further, it is desirable that the aspect ratio of the aggregate particles be 10 or less because the surface property improves.

It is desirable that the number of the aggregate particles per unit area be one particle/mm² or more and 100 particles/mm² or less. If the number of the aggregate particles per unit area is less than one particle/mm², the dielectric dissipation factor may be low. If, on the other hand, the number of the aggregate particles per unit area is more than 100 particles/mm², dielectric particles near the surface increase, and the surface may be highly charged. Thus, the adsorption of dust may increase.

Examples of methods for measuring the particle diameter of the primary particles of the dielectric, the particle diameter of the aggregate particles, the aspect ratio of the aggregate particles, and the number of the aggregate particles include the following methods.

That is, regarding the resin member for an electronic device according to the present embodiment, a transverse direction cross-section sample is produced by performing preprocessing, such as cross-section polishing, microtomy, ion milling, or the like. The ion milling is suitable because the ion milling achieves high smoothness in the cross-section and can prevent particles from falling off. If the temperature of the sample rises due to processing, the sample may be cooled by a cryogenic treatment or the like.

Then, an observation is made using a scanning electron microscope (SEM) under the following conditions, so that an SEM image of the cross-section is acquired. It is desirable to appropriately use the observation magnification according to the particle diameter. For example, it is desirable to make an observation at a magnification of 50,000 times when the particle diameter is 100 nm or less, make an observation at a magnification of 10,000 times when the particle diameter is more than 100 nm, and further make an observation at a magnification of 1,000 times when the particle diameter is more than 10 μm.

The obtained SEM image is subjected to binarization and image analysis under the following conditions, so that the median diameter of the dielectric particles in an arbitrary range of the cross-section of the resin member for an electronic device is determined as the particle diameter of the dielectric particles. For example, the optional range of the cross-section of the resin member for an electronic device can be a quadrangular region where the lengths of two adjacent sides are a length L and a length M. For example, the length L and the length M are 5 μm or more. It is desirable that the length L and the length M be 10 μm or more. For example, the length L and the length M are 500 μm or less, or for example, the length L and the length M are 100 μm or less. The length L and the length M may be the same as or different from each other. The ratio of the length L to the length M may be 0.5 or more and 2 or less. The binarization and the image analysis of the SEM image are performed using image processing software ImageJ of the National Institutes of Health (available at https://imagej.nih.gov/ij/).

### [Conditions]

### {Apparatus Name}

Schottky field emission scanning electron microscope JSM-F100 (manufactured by JEOL Ltd.)

### {Acceleration Voltage}

3 kV

### {Magnification}

10,000 times or 1,000 times

### {Measurement Range}

12.8 μm×9.6 μm (10,000 times) or 128 μm×96 μm (1,000 times)

### {Number of Evaluations}

10 areas/sample

### {Binarization and Image Analysis}

### ImageJ

### {Binarization Method}

MaxEntropy (The threshold is appropriately corrected so that the dielectric particles can be separated by binarization. If the dielectric particles cannot be binarized by the image processing software, an image in which only the dielectric particles are visually filled by separately using painting software or the like is prepared.)

### {Method for Calculating Particle Diameter}

The length of each aggregate particle at the position where the aggregate particle reached the maximum particle diameter was defined as a major axis, the length of the aggregate particle at the position where the aggregate particle reached the maximum length in a direction orthogonal to the major axis was defined as a minor axis, and the particle diameter of each particle was defined as (the major axis+the minor axis)/2.

The median (the median diameter; 50% particle diameter) was used as the representative value (the statistical value) of the particle diameters. Alternatively, the average value (the average particle diameter) or the mode (the mode diameter) can also be used as the representative value of the particle diameters.

### {Method for Calculating Aspect Ratio}

The major axis/the minor axis (the mass average value)

### {Method for Calculating Number of Aggregate Particles Per Unit Area}

From a binarized image, an aggregation of the primary particles of the dielectric in contact with each other was determined as a single aggregate particle. Then, the number of the aggregate particles was measured from an observation image, and a numerical value obtained by dividing the number of the aggregate particles by the observation area was determined as the number of the aggregate particles per unit area.

It is desirable that the contained amount of the dielectric particles be 0.1 mass % or more and 30 mass % or less. If the contained amount of the dielectric particles is less than 0.1 mass %, the dielectric dissipation factor is low, and the electromagnetic shielding property may be less likely to be exhibited. In a case where the contained amount of the dielectric particles is 1 mass % or more, the dielectric dissipation factor increases, and a further excellent electromagnetic shielding property is exhibited, which is more desirable. If, on the other hand, the contained amount of the dielectric particles is greater than 30 mass %, dielectric particles near the surface may increase, and the surface may be highly charged. Thus, the adsorption of dust may increase. In a case where the contained amount of the dielectric particles is 10 mass % or less, the adsorption amount of dust decreases, which is more desirable.

### [Elastomer Material]

It is known that the addition of an elastomer material to a resin improves the impact strength. Thus, in the present embodiment, an elastomer material may be contained to further improve the impact strength. It is desirable that the contained amount of the elastomer material be 30 mass % or less. The elastomer material is a copolymer composed of the combination of a hard segment serving as a cross-link point and a soft segment exhibiting rubber elasticity, and a thermoplastic elastomer having the properties of both plastic and rubber is desirable.

Examples of elastomer materials include a urethane elastomer, an ester elastomer, an amide elastomer, an acrylic elastomer, an olefinic elastomer, a styrene elastomer, and the like. It is desirable that the elastomer material be the acrylic elastomer or the ester elastomer.

Examples of urethane elastomers include an elastomer in which the hard segment is polyurethane including a urethane group and the soft segment is polyester including an ester bond or polyether including an ether bond, and the like. The urethane group and the ester bond have polarity.

Examples of ester elastomers include an elastomer in which the hard segment is polyester including an ester bond and the soft segment is polyester including an ester bond or polyether including an ether bond, and the like. The ester bonds have polarity.

Examples of amide elastomers include an elastomer in which the hard segment is polyamide including an amide group and the soft segment is polyester including an ester bond or polyether including an ether bond, and the like. The amide group and the ester bond have polarity.

Examples of acrylic elastomers include an elastomer in which the hard segment is polymethylmethacrylate that is a polymer of methyl methacrylate and includes an ester bond, and the soft segment is a copolymer of butyl acrylate, 2-ethylhexyl acrylate, or the like including an ester bond, and the like. Examples of the acrylic elastomer also include an elastomer in which the hard segment is polyolefin such as polyethylene or the like and the soft segment is polymethylmethacrylate that is a polymer of methyl methacrylate and includes an ester bond, and the like. The ester bonds have polarity.

Examples of olefinic elastomers include an elastomer in which the hard segment is a polyolefin such as polypropylene, polyethylene, or the like and the soft segment is ethylene propylene rubber, ethylene propylene diene rubber, or the like.

Examples of styrene elastomers include an elastomer in which the hard segment is polystyrene and the soft segment is butadiene, isoprene, ethylene, or the like.

In a case where the matrix resin is a polar polymer, it is desirable that the elastomer material include a polar group in terms of affinity for the matrix resin. For example, the polar group included in the elastomer material is a urethane group, an amide group, an ester bond, or the like. Particularly, it is desirable that the elastomer material include the ester bond in either one or both of the hard segment and the soft segment.

The elastomer material includes the polar group such as the ester bond or the like, whereby the elastomer material has heat resistance and can be melted and kneaded with a polar polymer, particularly a polar polymer having high heat resistance. The elastomer material including the ester bond has relatively high mechanical properties and contributes to an improvement in the physical properties.

The glass-transition point (the glass-transition temperature) of the elastomer material is lower than normal temperature, whereby the elastomer material acts as an elastomer at normal temperature. It is desirable that the glass-transition point of the elastomer material be lower than 0 °C. It is more desirable that the glass-transition point of the elastomer material be −20 °C or less.

The elastomer material is melted and kneaded in a melted state with the matrix resin that is a thermoplastic resin, and is finely dispersed as elastomer particles into the matrix resin, which improves the impact strength. Thus, it is desirable that the melting point of the elastomer material be lower than the heating temperature (the molding temperature) of the resin composition so that the elastomer material can be melted and kneaded with the matrix resin. The heating temperature of the resin composition is the temperature at which the matrix resin that is a thermoplastic polymer is melted. The heating temperature of the resin composition is higher than the glass-transition point of the matrix resin. In a case where the matrix resin is a crystalline polymer, it is desirable that the heating temperature of the resin composition be higher than the melting point of the matrix resin. Thus, it is desirable that the melting point of the elastomer material be lower than the melting point of the matrix resin. Although the melting point of the elastomer material may be higher than the melting point of the matrix resin, this can cause thermal degradation such as a decrease in the molecular weight of the matrix resin by heating the matrix resin to melt the elastomer material, or the like. In a case where the matrix resin is a crystalline polymer, the melting point of the elastomer material may be higher than the glass-transition point of the matrix resin. In a case where the matrix resin is a non-crystalline polymer, the melting point of the matrix resin is not defined, and thus it is desirable that the melting point of the elastomer material be lower than the glass-transition point of the matrix resin.

It is desirable that the glass-transition point of the matrix resin be 50 °C or more to ensure strength when the matrix resin is used. It is also desirable that the glass-transition point of the matrix resin be 200 °C or less, taking processability into account. It is desirable that the melting point of the matrix resin be 100 °C or more, taking heat resistance into account. It is desirable that the melting point of the matrix resin be 200 °C or more, and it is desirable that the melting point of the matrix resin be 300 °C or less, taking processability into account. It is desirable that the melting point of the elastomer material be 50 °C or more to ensure strength when the elastomer material is used. It is desirable that the melting point of the elastomer material be 300 °C or less, taking processability into account, and it is desirable that the melting point of the elastomer material be 200 °C or less.

The elastomer material has rubber elasticity, i.e., flexibility, and thus contributes to improving the impact strength of the matrix resin. When an impact is given to the molded body obtained by molding the resin composition containing the elastomer, the matrix resin is oriented about the elastomer particles and crazes are formed, whereby it is possible to soften the impact more efficiently. Thus, it is desirable that a large number of elastomer particles be finely dispersed. Thus, it is desirable that the particle diameter of the elastomer particles be 10 μm or less. It is more desirable that the particle diameter of the elastomer particles be 5 μm or less. It is suitable that the particle diameter of the elastomer particles be 0.1 μm or more so that the elastomer particles mechanically and efficiently function. It is more desirable that the particle diameter of the elastomer particles be 0.5 μm or more. Typically, the elastomer particles are particles formed by being dispersed and mixed by melting and kneading, and the particle diameter of such elastomer particles can be referred to as the “dispersed particle diameter” or the “dispersed particle diameter”. For example, the particle diameter can be measured by a method similar to that for the particle diameter of the dielectric particles.

### [Filler Particles]

It is known that the addition of filler particles to a resin improves mechanical properties, such as flexural modulus. Thus, in the present embodiment, filler particles, other than the dielectric particles, having an inorganic material as a main component may be contained to further improve the flexural modulus and the impact strength. It is desirable that the relative permittivity of the inorganic material be less than 10. It is desirable that the contained amount of the filler particles be 40 mass % or less. Examples of the shape of the filler particles include spheres such as a true sphere, an oblate sphere, and the like, a polyhedron, an amorphous shape, a plate-like shape, a scale-like shape, a needle-like shape, a fibrous shape, and the like. For example, the length of the needle-like or fibrous filler particles is 100 μm or less. It is desirable that the length of the needle-like or fibrous filler be 30 μm or less. It is more desirable that the length of the needle-like or fibrous filler be 10 μm or less.

The filler particles having an inorganic material as a main component are not particularly limited. Examples of the filler particles include particles of mica, glass fiber, glass sphere, zinc oxide, calcium carbonate, clays, talc, silicon oxide (silica), wollastonite, forsterite, zeolite, diatomite, silica sand, fly ash, pumice powder, slate powder, aluminum oxide (alumina), white alumina, aluminum sulfate, carbon fiber, carbon nanotube, metal fiber, barium sulfate, calcium sulfate, molybdenum disulfide, shirasu balloon, fly ash balloon, and the like.

The filler particles may each include a base of the inorganic material as the main component of the filler particles, and a surface layer of an organic material or an inorganic material covering the base. For example, the thickness of the surface layer is 100 nm or less. It is desirable that the thickness of the surface layer be 10 nm or less. In the filler particles having the inorganic material as the main component, the volume occupied by the inorganic material is greater than the volume occupied by the organic material. It is desirable that the volume occupied by the inorganic material be 90 volume % or more.

When an impact is given to the molded body containing the elastomer particles, the matrix resin is oriented about the elastomer particles, and crazes are formed, which can soften the impact more efficiently. To prevent the impact strength from decreasing because the filler particles serve as material defects, it is desirable that the filler particles have a small particle diameter. If the filler particles are coarse particles having a large particle diameter, the filler particles act as stress concentration points. Thus, the impact strength may decrease, and cracks may develop. On the other hand, to sufficiently disintegrate and disperse particles in a resin composition manufacturing process, it is desirable to avoid a dispersion failure due to particle aggregation caused by a small particle diameter. If the filler particles are fine particles having a small particle diameter, it may be difficult to disperse the filler particles due to particle aggregation in the resin composition manufacturing process. This may result in causing a material defect due to the particle aggregation and decreasing the impact strength, and cracks may develop.

Thus, for example, the particle diameter of the filler particles to be independently dispersed is 10 μm or less. It is desirable that the particle diameter of the filler particles be 5 μm or less. It is more desirable that the particle diameter of the filler particles be 2 μm or less. In a case where the particle diameter of the filler particles is m or less, it is possible to excellently prevent a decrease in the impact strength due to the addition of the filler particles. In a case where the particle diameter is 0.2 μm or more, it is possible to excellently finely disperse the filler particles into the matrix resin, and it is possible to prevent a decrease in the impact strength. Thus, it is desirable that the particle diameter of the filler particles be 0.2 μm or more and 10 μm or less. It is more desirable that the particle diameter of the filler particles be 0.2 μm or more and 5 μm or less. It is further desirable that the particle diameter of the filler particles be 0.2 μm or more and 2 μm or less. The resin composition may contain filler particles having a particle diameter of more than 10 μm. It is desirable that the particle diameter of the filler particles having a particle diameter of more than 10 μm be 100 μm or less. It is more desirable that the particle diameter of the filler particles having a particle diameter of more than 10 μm be 50 μm or less. It is further desirable that the particle diameter of the filler particles having a particle diameter of more than 10 μm be 30 μm or less. For example, the particle diameter can be measured by a method similar to that for the particle diameter of the dielectric particles.

It is desirable that in the filler particles, the base be subjected to surface treatment using a surface treatment agent, such as a coupling agent, a fatty acid, or the like. Regarding the filler particles subjected to the surface treatment, a commercial product subjected to surface treatment in advance may be used, or a surface treatment step may be separately provided when the resin composition is manufactured. The usage of the surface treatment agent can be calculated from the specific surface area of the filler particles as a processing target and the minimum cover area of the surface treatment agent. When filler particles having a small particle diameter are used, the specific surface area of the filler particles is large, and therefore, the usage of the surface treatment agent inevitably increases. Thus, the additive amount of the surface treatment agent to be used varies, and about 0.5 mass % to 5 mass % of the surface treatment agent is generally added to the filler particles. As the treatment method, a known method such as a dry treatment method including an integral blend method or the like or a wet treatment method using a surface treatment agent aqueous solution or the like can be used. A surface layer formed by the surface treatment constitutes a part of the filler particles.

Examples of surface treatment agents include silane coupling agents such as vinyltrimethoxysilane, vinyltriethoxysilane, 3-glycidoxypropyltrimethoxysilane, 3-glycidoxypropyltriethoxysilane, 3-methacryloxypropyltrimethoxysilane, 3-methacryloxypropyltriethoxysilane, 3-acryloxypropyltrimethoxysilane, 3-aminopropyltrimethoxysilane, tris-(trimethoxysilylpropyl)isocyanurate, 3-trimethoxysilylpropylsuccinic anhydride, and the like. Alternatively, a titanate or aluminate coupling agent may be used. Examples of the fatty acid include a lauric acid, a stearic acid, an oleic acid, and the like. Among these, the silane coupling agents are desirable. One of these surface treatment agents may be used, or two or more of these surface treatment agents may be used in combination.

### [Other Components]

Various other additives may be blended with the resin composition according to the present embodiment where necessary. The types of the additives are not particularly limited so long as the additives are generally used for the blending of a thermoplastic resin or a thermoplastic elastomer material. Examples of various additives for improving the functionality include fire retardants, lubricants and release agents such as a wax, various fatty acids, a fatty acid amide, a fatty acid ester, a metallic salt of a fatty acid, and the like, various antistatic agents, sliding contact property improvers such as a fatty acid ester, polyolefin and olefin copolymer elastomers, polysiloxane, and the like, decomposition inhibitors such as a polyamide resin, a polymer of acrylamide, an amide compound, an amino-substituted triazine compound, a derivative of the amino-substituted triazine compound, urea, a derivative of the urea, a hydrazine derivative, an imidazole compound, an imide compound, and an epoxy compound, formic scavengers such as melamine, a hydroxide of an alkali metal, a carbonate of an alkali metal, and the like, and fire retardants such as an organic phosphorus compound and the like. Examples of various additives for improving the long-term stability include ultraviolet absorbers such as a benzotriazole compound, a benzophenone compound, a phenyl salicylate compound, and the like, a hindered amine light stabilizer, a hindered phenol antioxidant, and the like. One or more of the above additives may be used in combination.

The resin composition according to the present embodiment may contain at least one of, other than the dielectric particles, a metal material including a transition metal element, a compound material including a transition metal element, a metal material including a representative metal element, and a compound material including a representative metal element.

Examples of the transition metal element include titanium (Ti), chromium (Cr), manganese (Mn), iron (Fe), cobalt (Co), nickel (Ni), copper (Cu), zirconium (Zr), niobium (Nb), molybdenum (Mo), hafnium (Hf), tantalum (Ta), tungsten (W), palladium (Pd), platinum (Pt), silver (Ag), gold (Au), and the like. Examples of the representative metal element include sodium (Na), magnesium (Mg), calcium (Ca), strontium (Sr), barium (Ba), zinc (Zn), aluminum (Al), gallium (Ga), germanium (Ge), indium (In), tin (Sn), antimony (Sb), and the like. Although silicon (Si) and arsenic (As) can be classified into semimetals with the germanium (Ge) and the antimony (Sb), the silicon (Si) and the arsenic (As) are treated as non-metal elements here. Each of the metal materials is an elemental metal or an alloy, and, for example, a metal compound, which is a compound including a metal element, is an oxide, a nitride, a carbide, an inorganic acid salt, or an organic acid salt of the metal element. The metal compound may be a complex compound including a plurality of transition metal elements, a plurality of representative metal elements, or a transition metal element and a representative metal element. Although compounds are classified into inorganic compounds and organic compounds, an organic compound that is a metal compound, i.e., an organometallic compound, is a compound having a bond between carbon and a metal element.

The above material including the transition metal element or the representative metal element may be filler particles having a particle diameter of 0.1 μm or more when dispersed in the matrix resin, or may be particles having a particle diameter of less than 0.1 μm. When elastomer particles are included, the above material including the transition metal element or the representative metal element can be particles smaller than the elastomer particles, or can be particles dispersed in the elastomer particles. Alternatively, the above material including the transition metal element or the representative metal element may be dissolved in the matrix resin or the elastomer particles.

It is desirable that the contained amount of the above material including the transition metal element or the representative metal element be 0.01 mass % or more and 5 mass % or less and be smaller than the contained amounts of the matrix resin and the dielectric particles. In this range, ferroelectric interaction may occur, and the dielectric dissipation factor may increase.

In a case where the contained amount of a particular metal element differs between the matrix resin and the elastomer material, a distribution image (a mapping image) of the metal element is acquired, so that the matrix resin and the elastomer material can be easily distinguished in an observation image. For example, aluminum (Al), germanium (Ge), antimony (Sb), or titanium (Ti) can be included in a compound as a polymerization catalyst when a polar polymer is polymerized, and can be dissolved or dispersed into the matrix resin. Alternatively, the material including the transition metal element or the representative metal element can be included in a compound as a pigment for coloring the resin composition and can be dispersed into the matrix resin. Alternatively, for example, a plurality of types of filler particles may include filler particles having calcium carbonate as a main component and filler particles having titanium oxide as a main component, and both filler particles may be independently dispersed.

### <Method for Manufacturing Resin Composition>

Although a method for manufacturing the resin composition is not particularly limited, it is desirable to form the aggregate particles by causing the primary particles of the dielectric to aggregate in advance. Specifically, for example, polyvinyl butyral, dioctyl phthalate, toluene, ethanol, or the like are added to the primary particles of the dielectric, and the added materials are mixed and dispersed using a ball mill, thereby preparing a dielectric slurry. Then, a polyethylene terephthalate film or the like is coated with the dielectric slurry using an applicator or the like, and the dielectric slurry is dried, thereby forming a dielectric layer. The dielectric layer is peeled using a squeegee or the like, and the peeled dielectric layer is pulverized using a ball mill or the like, whereby it is possible to obtain the aggregate particles of the dielectric. At this time, for example, the particle diameter and the aspect ratio of the aggregate particles can be adjusted by adjusting the pulverization time.

Examples of methods for mixing the matrix resin and the dielectric particles include a method for melting the resin composition using a screw or a blade, and applying shear to the resin composition as in a twin-screw extruder, a kneader, or the like. Examples of the method for mixing the matrix resin and the dielectric particles also include a method for melting the resin composition by passing the resin composition on a plurality of rolls close to each other, and applying shear to the resin composition as in a roll mill. Examples of the method for mixing the matrix resin and the dielectric particles also include a method for continuously discharging the resin composition subjected to shear as a strand and finely cutting the strand, thereby pelletizing the resin composition, and a method for taking out the resin composition as a mass of resin and putting the mass of resin in a pulverizer, thereby making the resin composition fine. A method for manufacturing the resin composition according to the present embodiment may include the step of melting and kneading the matrix resin and the dielectric particles. Examples of a kneading apparatus include a twin-screw extruder, a twin roll, and the like. Specifically, examples of the kneading apparatus include TEM extruder (manufactured by Shibaura Machine Co., Ltd.), TEX biaxial kneader (manufactured by The Japan Steel Works, Ltd.), PCM kneader (manufactured by Ikegai Iron Works Co., Ltd.), KNEADEX (manufactured by Nippon Coke & Engineering Co., Ltd.), and the like.

### <Molding Method>

A molding method is not particularly limited. Examples of the molding method include injection molding, extrusion molding, press molding, transfer molding, and the like. The injection molding may be performed using pellets manufactured by extrusion molding using a metal mold. Among these, injection molding in which the resin composition is melted and injected into a metal mold is desirable. This is because the injection molding has a short molding cycle time and can efficiently manufacture a molded body. The molded body formed by the injection molding can be referred to as an injection-molded body. The molded body formed by the injection molding may further be processed by blow molding or the like.

### <<Electronic Device>>

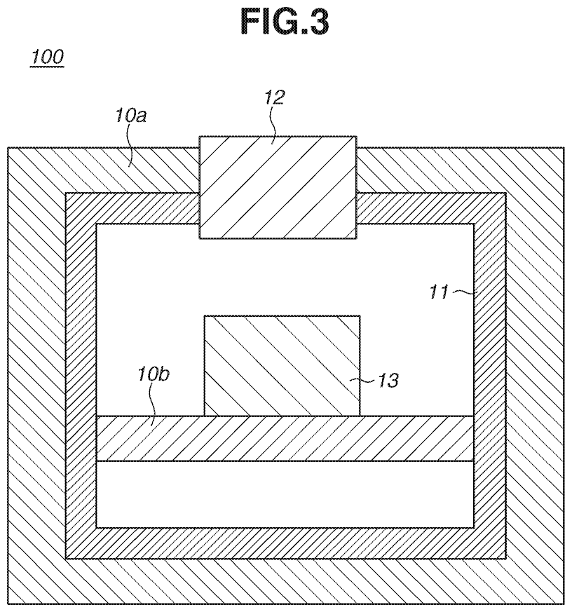

As illustrated in FIG. 3, an electronic device 100 according to the present embodiment includes resin members 10a and 10b for an electronic device according to the present embodiment. Examples of the electronic device 100 include office devices such as a printer, a copying machine, and the like, medical devices such as a computed tomography (CT) apparatus and the like, video devices such as a projector, a display, and the like, and the like. These various electronic devices each include at least one of an electric component 13, an optical component 12, and a metal component 11 in addition to the resin members 10a and 10b for an electronic device according to the present embodiment. The electric component 13, the optical component 12, or the metal component 11 achieves the function of the electronic device 100. The metal component 11 can also be used for a housing for ensuring the mechanical strength of the electronic device 100. The volume of each of the resin members 10a and 10b can be 10³ mm³ or more. It is desirable that the volume of each of the resin members 10a and 10b be 10⁴ mm³ or more. The volume of each of the resin members 10a and 10b may be 10⁸ mm³ or less, or may be 10⁶ mm³ or less. The greater the volume is, the more desirable it is that the thickness of the resin member be 0.5 mm or more. The thickness of the resin member may be 1 mm or more, or may be 5 mm or less.

The resin members 10a and 10b for an electronic device can be used as members for ensuring the mechanical strength of the electronic device 100 or mechanically protecting the electronic device 100. The resin member 10a for an electronic device may be an exterior body, such as an exterior cover, of the electronic device 100. The exterior body may be fixed to the metal housing (the metal component 11). The resin member 10b for an electronic device may be an interior body, such as a mechanism component, of the device 100. The interior body may be fixed to the metal housing (the metal component 11). It is desirable that the resin members 10a and 10b for an electronic device have a radio wave shielding property in terms of a stable operation of the electronic device 100 and a reduction in radio emission from the electronic device 100.

### EXAMPLES

The present disclosure is further described below by way of examples. Materials used in the present examples (also including comparative examples) are as follows.

### (A) Matrix Resin

TABLE 1

| | | | Glass | |
|---|---|---|---|---|
| | | | Transition | Melting |
| | | | Temperature | Point |
| | Compound | Product Name | [°C] | [°C] |
| A-1 | Polyethylene | Teijin Ltd. | 71 | 252 |
| | terephthalate | “TRN-8550FF” | | |
| A-2 | Polycarbonate | Mitsubishi Engineering- | 142 | — |
| | | Plastics Corporation | | |
| | | “HL-3503” | | |
| A-3 | Polyethylene | Japan Polyethylene | −123 | 126 |
| | | Corporation | | |
| | | “NOVATEC L UJ990” | | |

### (B) Ferroelectric Particles

TABLE 2

| | | | Particle |
|---|---|---|---|
| | | | Diameter |
| | Compound | Product Name | [nm] |
| B-1 | Barium titanate | TODA KOGYO CORP. | 60 |
| | | “T-BTO-060FR” | |
| B-2 | Barium titanate | TODA KOGYO CORP. | 300 |
| | | “T-BTO-300FR” | |
| B-3 | Barium titanate | Fuji Titanium Industry Co., Ltd. | 700 |
| | | “HPT” | |
| B-4 | Strontium titanate | Sakai Chemical Industry Co., | 300 |
| | | Ltd. | |
| | | “ST-03” | |
| B-5 | Barium titanate | Nippon Chemical Industrial Co., | 1400 |
| | | Ltd. | |
| | | “BTE-UP” | |

### (C) Other Components

TABLE 3

| | Compound | Product Name | Properties |
|---|---|---|---|
| C-1 | Calcium carbonate | Nitto Funka Kogyo K.K. | Average particle |
| | particles | “NS#100” | diameter: 2.1 μm |
| C-2 | Silica particles | Denka Company Limited | Average particle |
| | | “Fused Silica SFP-20M” | diameter: 0.4 μm |
| C-3 | Acrylic elastomer | Kuraray Co., Ltd. | Glass transition |
| | (containing ester bond) | “KURARITY LA4285” | temperature: −52 °C |
| | | | Melting point: 75 °C |
| C-4 | Glass fiber | Nippon Electric Glass | Fiber diameter: 13 μm |
| | | Co., Ltd. | Fiber length: 3 mm |
| C-5 | Nickel powder | TOHO TITANIUM CO., | Average particle |
| | | LTD. | diameter: 200 nm |
| C-6 | Aluminum powder | TOYO ALUMINIUM | Average particle |
| | | K.K. | diameter: 4 μm |
| | | “Alpaste 0670TS” | |
| C-7 | Carbodiimide | Nisshinbo Chemical Inc. | — |
| | compound | “CARBODILITE HMV- | |
| | | 15CA” | |

### Example 1

### (1) Manufacturing of Aggregate Particles

69 parts by mass of toluene and 46 parts by mass of ethanol were added to 50 parts by mass of ferroelectric particles B-1, 5 parts by mass of polyvinyl butyral (“S-LEC B KBM-2” manufactured by Sekisui Chemical Co., Ltd.), and 2 parts by mass of dioctyl phthalate (“dioctyl phthalate Cica special grade” manufactured by Kanto Chemical Co., Inc.), and these materials were mixed and dispersed using a ball mill, thereby preparing a ferroelectric slurry.

A polyethylene terephthalate film was evenly coated with the ferroelectric slurry using an applicator. Then, the ferroelectric slurry was dried for 10 minutes at 80 °C, thereby obtaining a ferroelectric layer. The ferroelectric layer was peeled using a squeegee. The peeled ferroelectric layer was pulverized using a ball mill, thereby obtaining the aggregate particles of the ferroelectric.

### (2) Manufacturing of Pellet

95 parts by mass of a matrix resin A-1 and 5 parts by mass of the obtained aggregate particles were kneaded using a twin-screw extruder, thereby obtaining a pellet. The melt viscosity of the pellet was measured and evaluated by the following method. Table 4 illustrates the results.

### <Melt Viscosity>

Melt viscosity: The melt viscosity at a shear velocity of 1,000/sec was measured in compliance with JIS-K-7199:1999, specifically, using INTESCO fully automatic capillary rheometer (INTESCO Co., Ltd.) and using a capillary where d=1 mm and L/D=30. The melt viscosity was evaluated based on the following criteria. A to D were highly rated, and E was lower rated.

A: 150 Pa·s or less
B: More than 150 Pa·s and 250 Pa·s or less
C: More than 250 Pa·s and 400 Pa·s or less
D: More than 400 Pa·s and 1,000 Pa·s or less
E: More than 1,000 Pa·s

### (3) Manufacturing of Molded Bodies (Resin Member for Electronic Device and Test Piece)

### (3-1) Manufacturing of Resin Member for Electronic Device

The obtained pellet was injected into a metal mold in the form of a resin member for an electronic device having a length of 120 mm, a width of 120 mm, a thickness of 5 mm, and a surface roughness Ra of 1.0 μm, thereby injection-molding a resin member for an electronic device. The ferroelectric included in the resin member for an electronic device was subjected to an electron microscope observation, and the particle diameter, the aspect ratio, and the number of the aggregate particles were obtained. Table 4 illustrates the results.

The amount of charge on the surface, the amount of attached dust, and the surface roughness of the resin member for an electronic device were measured and evaluated by the following methods. Table 4 illustrates the results.

### <Amount of Charge on Surface>

The molded resin member for an electronic device was rubbed 100 times using a low dust generation wiper (“Bemcot S-2” manufactured by Asahi Kasei Corporation) and left for 10 minutes. Then, an upper portion of the resin member for an electronic device was measured using a digital electrostatic potential measuring device (“KSD-0103” manufactured by Kasuga Denki, Inc.). The upper portion of the resin member for an electronic device was measured three times, and the average of the measurement results was determined as a measured value.

### <Amount of Attached Dust>

After a cellulose powder (“cellulose powder through 38 μm” manufactured by FUJIFILM Wako Pure Chemical Corporation) was attached to the surface of the molded resin member for an electronic device, air was swiftly sprayed to the surface, thereby removing the cellulose powder on the surface. The amount of attached dust was evaluated based on the following criteria. A to D were highly rated, and E was lower rated.

A: The cellulose powder was not attached in the state where the cellulose powder was not removed.
B: The cellulose powder was not attached after the cellulose powder was removed.
C: A small amount of the cellulose powder was attached after the cellulose powder was removed.
D: A large amount of the cellulose powder was attached after the cellulose powder was removed.
E: The cellulose powder was attached to the entire surface after the cellulose powder was removed.

### <Surface Roughness (Evaluation of Moldability)>

The surface roughness of the molded resin member for an electronic device was measured, and the moldability was evaluated. Specifically, the arithmetic average roughness (Ra) of the molded resin member for an electronic device was measured using a surface roughness measuring device in compliance with JIS-B0601, and the moldability was evaluated based on the following criteria. A to D were highly rated, and E was lower rated.

A: 0.3 μm or less
B: More than 0.3 μm and 0.5 μm or less
C: More than 0.5 μm and 0.7 μm or less
D: More than 0.7 μm and 1.0 μm or less
E: More than 1.0 μm

### (3-2) Manufacturing of Test Piece

The obtained pellet was injected into a metal mold for a cylindrical test piece having a height of 30 mm and a diameter of 8 mm, thereby injection-molding a test piece. The dielectric dissipation factor of the test piece was measured and evaluated by the following method. Table 4 illustrates the results.

### <Dielectric Dissipation Factor (Evaluation of Electromagnetic Shielding Property)>

The dielectric dissipation factor of the test piece was measured, and the electromagnetic shielding property was evaluated. Specifically, the permittivity and the dielectric dissipation factor at 3 GHz of the test piece were measured using perturbative cavity resonator type DPS18 manufactured by KEYCOM Corporation, and the electromagnetic shielding property was evaluated based on the following criteria.

A: 0.01 or more
B: Less than 0.01 and 0.001 or more
C: Less than 0.001 and 0.0005 or more
D: Less than 0.0005 and 0.0002 or more
E: Less than 0.0002

### Comparative Example 1

A pellet and molded bodies were manufactured and evaluated similarly to example 1 except that a ferroelectric powder B-5 was used as it was without manufacturing aggregate particles. Table 4 illustrates the results. The amount of charge on the surface was −4.1 kV, the amount of attached dust was rated E, and the deterioration in dust attachment was confirmed. It is considered that the amount of charge on the surface was great and dust attachment deteriorated because the particle diameter of the ferroelectric particles was great.

### Comparative Example 2

A pellet and molded bodies were manufactured and evaluated similarly to example 1 except that a ferroelectric powder B-2 was used as it was without manufacturing aggregate particles. Table 4 illustrates the results. The melt viscosity was 2,356 Pa·s and was rated E, and the deterioration of the fluidity was confirmed. It is considered that the viscosity increased because ferroelectric particles having a small particle diameter were dispersed into the matrix resin without aggregating.

### Comparative Example 3

Aggregate particles, a pellet, and molded bodies were manufactured and evaluated similarly to example 1 except that ferroelectric particles B-3 were used. Table 4 illustrates the results. The surface roughness Ra was 1.61 μm and was rated E, and the deterioration of the surface property was confirmed. It is considered that the surface property deteriorated because the particle diameter of the aggregate particles was large.

### Example 2

Aggregate particles, a pellet, and molded bodies were manufactured and evaluated similarly to example 1 except that ferroelectric particles B-2 were used. Table 4 illustrates the results.

### Example 3

Aggregate particles, a pellet, and molded bodies were manufactured and evaluated similarly to example 2 except that in the manufacturing of the aggregate particles, the particle diameter and the aspect ratio of the aggregate particles were adjusted by changing the time in which the pulverization was performed using the ball mill. Table 4 illustrates the results.

### Examples 4 to 7

Aggregate particles, a pellet, and molded bodies were manufactured and evaluated similarly to example 1 except that in the manufacturing of the aggregate particles, the particle diameter and the aspect ratio of the aggregate particles were adjusted by changing the time in which the pulverization was performed using the ball mill. Table 4 illustrates the results.

### Example 8

Aggregate particles, a pellet, and molded bodies were manufactured and evaluated similarly to example 1 except that ferroelectric particles B-4 were used. Table 4 illustrates the results.

### Examples 9 and 10

Aggregate particles, a pellet, and molded bodies were manufactured and evaluated similarly to example 2 except that matrix resins A-2 and A-3 were used in examples 9 and 10, respectively. Table 5 illustrates the results.

### Examples 11 to 14

Aggregate particles, a pellet, and molded bodies were manufactured and evaluated similarly to example 1 except that the blending amount of ferroelectric particles was changed as illustrated in table 5. Table 5 illustrates the results.

### Examples 15 to 21

Aggregate particles, a pellet, and molded bodies were manufactured and evaluated similarly to example 1 except that in the manufacturing of the pellet, other components C-1 to C-7 were kneaded together with the matrix resin and the aggregate particles by amounts illustrated in table 5 in examples 15 to 21, respectively. Table 5 illustrates the results.

TABLE 4

| | | | Ex. | CEx | | | | | |
|---|---|---|---|---|---|---|---|---|---|
| | | | 1 | 1 | | 2 | | 3 | |
| Material | Matrix resin | A-1 | 95 | 95 | | 95 | | 95 | |
| Composition | [parts by mass] | A-2 | 0 | 0 | | 0 | | 0 | |
| | | A-3 | 0 | 0 | | 0 | | 0 | |
| | Ferroelectric | B-1 | 5 | 0 | | 0 | | 0 | |
| | particles | B-2 | 0 | 0 | | 5 | | 0 | |
| | [parts by mass] | B-3 | 0 | 0 | | 0 | | 5 | |
| | | B-4 | 0 | 0 | | 0 | | 0 | |
| | | B-5 | 0 | 5 | | 0 | | 0 | |
| | Other | C-1 | 0 | 0 | | 0 | | 0 | |
| | component | C-2 | 0 | 0 | | 0 | | 0 | |
| | [parts by mass] | C-3 | 0 | 0 | | 0 | | 0 | |
| | | C-4 | 0 | 0 | | 0 | | 0 | |
| | | C-5 | 0 | 0 | | 0 | | 0 | |
| | | C-6 | 0 | 0 | | 0 | | 0 | |
| | | C-7 | 0 | 0 | | 0 | | 0 | |
| | | | Ex | | | | | | |
| | | | 2 | 3 | 4 | 5 | 6 | 7 | 8 |
| Material | Matrix resin | A-1 | 95 | 95 | 95 | 95 | 95 | 95 | 95 |
| Composition | [parts by mass] | A-2 | 0 | 0 | 0 | 0 | 0 | 0 | 0 |
| | | A-3 | 0 | 0 | 0 | 0 | 0 | 0 | 0 |
| | Ferroelectric | B-1 | 0 | 0 | 5 | 5 | 5 | 5 | 0 |
| | particles | B-2 | 5 | 5 | 0 | 0 | 0 | 0 | 0 |
| | [parts by mass] | B-3 | 0 | 0 | 0 | 0 | 0 | 0 | 0 |
| | | B-4 | 0 | 0 | 0 | 0 | 0 | 0 | 5 |
| | | B-5 | 0 | 0 | 0 | 0 | 0 | 0 | 0 |
| | Other | C-1 | 0 | 0 | 0 | 0 | 0 | 0 | 0 |
| | component | C-2 | 0 | 0 | 0 | 0 | 0 | 0 | 0 |
| | [parts by mass] | C-3 | 0 | 0 | 0 | 0 | 0 | 0 | 0 |
| | | C-4 | 0 | 0 | 0 | 0 | 0 | 0 | 0 |
| | | C-5 | 0 | 0 | 0 | 0 | 0 | 0 | 0 |
| | | C-6 | 0 | 0 | 0 | 0 | 0 | 0 | 0 |
| | | C-7 | 0 | 0 | 0 | 0 | 0 | 0 | 0 |

| | | | Ex | CEx | | |
|---|---|---|---|---|---|---|
| | | | 1 | 1 | 2 | 3 |
| Evaluation | Ferroelectric | Particle | 60 | 1400 | 300 | 700 |
| | particles | diameter | | | | |
| | | [μm] | | | | |
| Results | Aggregate | Particle | 5 | — | — | 800 |
| | particles | diameter | | | | |
| | | [μm] | | | | |
| | | Aspect ratio | 5.6 | 1 | 1 | 4.1 |
| | | Number | 26 | 225 | 1046 | 0.38 |
| | | [/mm²] | | | | |
| | Amount of charge on | | −0.3 | −4.1 | −1.3 | −2.8 |
| | surface [kV] | | | | | |
| | Dust attachment | | A | E | B | D |
| | Melt | Measured | 174 | 121 | 2356 | 135 |
| | viscosity | value | | | | |
| | | [Pa · s] | | | | |
| | | Rating | B | A | E | A |
| | Surface | Measured | 0.26 | 0.28 | 0.65 | 1.61 |
| | roughness | value | | | | |
| | | [μm] | | | | |
| | | Rating | A | A | C | E |
| | Dissipation | Measured | 0.003 | 0.0001 | 0.0003 | 0.0002 |
| | tangent | value | | | | |
| | | Rating | B | E | D | D |

| | | | Ex | | | | | | |
|---|---|---|---|---|---|---|---|---|---|
| | | | 2 | 3 | 4 | 5 | 6 | 7 | 8 |
| Evaluation | Ferroelectric | Particle | 300 | 300 | 60 | 60 | 60 | 60 | 300 |
| | particles | diameter | | | | | | | |
| | | [μm] | | | | | | | |
| Results | Aggregate | Particle | 12 | 1 | 13 | 24 | 41 | 83 | 16 |
| | particles | diameter | | | | | | | |
| | | [μm] | | | | | | | |
| | | Aspect ratio | 6.4 | 1.1 | 3 | 9 | 16 | 35 | 3.1 |
| | | Number | 64 | 96 | 23 | 13 | 7.6 | 3.7 | 19 |
| | | [/mm²] | | | | | | | |
| | Amount of charge on | | −0.5 | −3.4 | −1.7 | −1.4 | −1.2 | −1.1 | −1.4 |
| | surface [kV] | | | | | | | | |
| | Dust attachment | | A | D | C | B | B | B | B |
| | Melt | Measured | 132 | 294 | 128 | 131 | 142 | 134 | 123 |
| | viscosity | value | | | | | | | |
| | | [Pa · s] | | | | | | | |
| | | Rating | A | C | A | A | A | A | A |
| | Surface | Measured | 0.39 | 0.82 | 0.36 | 0.46 | 0.53 | 0.75 | 0.82 |
| | roughness | value | | | | | | | |
| | | [μm] | | | | | | | |
| | | Rating | B | D | B | B | C | D | D |
| | Dissipation | Measured | 0.0006 | 0.002 | 0.006 | 0.011 | 0.012 | 0.014 | 0.0006 |
| | tangent | value | | | | | | | |
| | | Rating | C | B | B | A | A | A | C |

TABLE 5

| | | | Ex | | | | | |
|---|---|---|---|---|---|---|---|---|
| | | | 9 | 10 | 11 | 12 | 13 | 14 |
| Material | Matrix resin | A-1 | 0 | 0 | 99.9 | 99 | 90 | 70 |
| Composition | [parts by mass] | A-2 | 95 | 0 | 0 | 0 | 0 | 0 |
| | | A-3 | 0 | 95 | 0 | 0 | 0 | 0 |
| | Ferroelectric | B-1 | 0 | 0 | 0.1 | 1 | 10 | 30 |
| | particles | B-2 | 5 | 5 | 0 | 0 | 0 | 0 |
| | [parts by mass] | B-3 | 0 | 0 | 0 | 0 | 0 | 0 |
| | | B-4 | 0 | 0 | 0 | 0 | 0 | 0 |
| | | B-5 | 0 | 0 | 0 | 0 | 0 | 0 |
| | Other | C-1 | 0 | 0 | 0 | 0 | 0 | 0 |
| | component | C-2 | 0 | 0 | 0 | 0 | 0 | 0 |
| | [parts by mass] | C-3 | 0 | 0 | 0 | 0 | 0 | 0 |
| | | C-4 | 0 | 0 | 0 | 0 | 0 | 0 |
| | | C-5 | 0 | 0 | 0 | 0 | 0 | 0 |
| | | C-6 | 0 | 0 | 0 | 0 | 0 | 0 |
| | | C-7 | 0 | 0 | 0 | 0 | 0 | 0 |

| | | | Ex | | | | | | |
|---|---|---|---|---|---|---|---|---|---|
| | | | 15 | 16 | 17 | 18 | 19 | 20 | 21 |
| Material | Matrix resin | A-1 | 94 | 94 | 94 | 94 | 94 | 94 | 94 |
| Composition | [parts by mass] | A-2 | 0 | 0 | 0 | 0 | 0 | 0 | 0 |
| | | A-3 | 0 | 0 | 0 | 0 | 0 | 0 | 0 |
| | Ferroelectric | B-1 | 5 | 5 | 5 | 5 | 5 | 5 | 5 |
| | particles | B-2 | 0 | 0 | 0 | 0 | 0 | 0 | 0 |
| | [parts by mass] | B-3 | 0 | 0 | 0 | 0 | 0 | 0 | 0 |
| | | B-4 | 0 | 0 | 0 | 0 | 0 | 0 | 0 |
| | | B-5 | 0 | 0 | 0 | 0 | 0 | 0 | 0 |
| | Other | C-1 | 1 | 0 | 0 | 0 | 0 | 0 | 0 |
| | component | C-2 | 0 | 1 | 0 | 0 | 0 | 0 | 0 |
| | [parts by mass] | C-3 | 0 | 0 | 1 | 0 | 0 | 0 | 0 |
| | | C-4 | 0 | 0 | 0 | 1 | 0 | 0 | 0 |
| | | C-5 | 0 | 0 | 0 | 0 | 1 | 0 | 0 |
| | | C-6 | 0 | 0 | 0 | 0 | 0 | 1 | 0 |
| | | C-7 | 0 | 0 | 0 | 0 | 0 | 0 | 1 |

| | | | Ex. | | | | | |
|---|---|---|---|---|---|---|---|---|
| | | | 9 | 10 | 11 | 12 | 13 | 14 |
| Evaluation | Ferroelectric | Particle | 300 | 300 | 60 | 60 | 60 | 60 |
| Results | particles | diameter | | | | | | |
| | | [μm] | | | | | | |
| | Aggregate | Particle | 12 | 12 | 5 | 5 | 5 | 5 |
| | particles | diameter | | | | | | |
| | | [μm] | | | | | | |
| | | Aspect ratio | 6.4 | 6.4 | 5.6 | 5.6 | 5.6 | 5.6 |
| | | Number | 25 | 23 | 1.2 | 6.1 | 46 | 98 |
| | | [/mm²] | | | | | | |
| | Amount of charge on | | −2.2 | −2.9 | −0.3 | −0.3 | −0.6 | −0.8 |
| | surface [kV] | | | | | | | |
| | Dust attachment | | C | D | A | A | A | A |
| | Melt | Measured | 114 | 136 | 123 | 142 | 341 | 516 |
| | viscosity | value | | | | | | |
| | | [Pa · s] | | | | | | |
| | | Rating | A | A | A | A | C | D |
| | Surface | Measured | 0.42 | 0.37 | 0.25 | 0.28 | 0.39 | 0.51 |
| | roughness | value | | | | | | |
| | | [μm] | | | | | | |
| | | Rating | B | B | A | A | B | C |
| | Dissipation | Measured | 0.0007 | 0.0006 | 0.008 | 0.01 | 0.014 | 0.018 |
| | tangent | value | | | | | | |
| | | Rating | C | C | B | A | A | A |

| | | | Ex | | | | | | |
|---|---|---|---|---|---|---|---|---|---|
| | | | 15 | 16 | 17 | 18 | 19 | 20 | 21 |
| Evaluation | Ferroelectric | Particle | 60 | 60 | 60 | 60 | 60 | 60 | 60 |
| Results | particles | diameter | | | | | | | |
| | | [μm] | | | | | | | |
| | Aggregate | Particle | 5 | 5 | 5 | 5 | 5 | 5 | 5 |
| | particles | diameter | | | | | | | |
| | | [μm] | | | | | | | |
| | | Aspect ratio | 5.6 | 5.6 | 5.6 | 5.6 | 5.6 | 5.6 | 5.6 |
| | | Number | 46 | 35 | 53 | 44 | 68 | 43 | 51 |
| | | [/mm2] | | | | | | | |
| | Amount of charge on | | −0.3 | −0.3 | −0.3 | −0.3 | −0.3 | −0.3 | −0.3 |
| | surface [kV] | | | | | | | | |
| | Dust attachment | | A | A | A | A | A | A | A |
| | Melt | Measured | 188 | 174 | 174 | 189 | 170 | 168 | 195 |
| | viscosity | value | | | | | | | |
| | | [Pa · s] | | | | | | | |
| | | Rating | B | B | B | B | B | B | B |
| | Surface | Measured | 0.26 | 0.25 | 0.26 | 0.25 | 0.26 | 0.28 | 0.24 |
| | roughness | value | | | | | | | |
| | | [μm] | | | | | | | |
| | | Rating | A | A | A | A | A | A | A |
| | Dissipation | Measured | 0.003 | 0.003 | 0.002 | 0.003 | 0.008 | 0.003 | 0.003 |
| | tangent | value | | | | | | | |
| | | Rating | B | B | B | B | B | B | B |

The present disclosure is not limited to the embodiments and examples described above, and many modifications are possible within the technical idea of the present disclosure. In addition, the advantages described in the embodiments and examples of the present disclosure merely enumerate the most desirable advantages resulting from the present disclosure, and the advantages of the present disclosure are not limited to those described in the embodiments and examples.

In addition, new matters may be added to at least one embodiment. The disclosure of the present specification includes not only matters explicitly described in the present specification but also all matters that can be understood from the present specification and the drawings attached to the present specification.

With respect to specific numerical ranges exemplified in the present specification, the expression “e to f” (where e and f are numerals) means “greater than or equal to e and/or less than or equal to f”. In addition, with respect to the specific numerical ranges exemplified, where a range “i to j” and a range “m to n” (where i, j, m, and n are numerals) are written together, the pair of the lower limit and the upper limit is not limited to the pair of i and j or the pair of m and n. For example, combinations of lower limits and upper limits of multiple pairs may be considered. That is, where the range “i to j” and the range “m to n” are written together, a range “i to n” may be considered or a range “m to j” may be considered, insofar as no inconsistency arises. Further, “greater than or equal to e” means being e or greater than e (exceeding e), and a value greater than e may be adopted without adopting e. Further, “less than or equal to f” means being f or less than f (less than f), and a value less than f may be adopted without adopting f.

The disclosure of the present specification includes the complementary set of the individual concepts described in the present specification. That is, for example, if the present specification describes that “A is B,” then even if a description that “A is not B” is omitted, it can be said that the present specification discloses that “A is not B.” This is because, when a description that “A is B” is provided, it is premised that the case where “A is not B” has been taken into consideration.

### <<Included Configurations>>

The disclosure of the present embodiment includes the following configurations.

### (Configuration 1)

A resin member for an electronic device, comprising:
a matrix resin and dielectric particles dispersed in the matrix resin,
wherein the dielectric particles are aggregate particles each of which is an aggregate of ferroelectric particles,
wherein a particle diameter of the ferroelectric particles is 10 nm or more and 1,000 nm or less, and
wherein a particle diameter of the aggregate particles is 1 μm or more and 100 μm or less.

### (Configuration 2)

A resin member for an electronic device, comprising:
a matrix resin and dielectric particles dispersed in the matrix resin,
wherein the dielectric particles are aggregate particles each of which is an aggregate of paraelectric particles having a relative permittivity of 10 or more,
wherein a particle diameter of the paraelectric particles is 10 nm or more and 1,000 nm or less, and
wherein a particle diameter of the aggregate particles is 1 μm or more and 100 μm or less.

### (Configuration 3)

The resin member according to configuration 1 or 2, wherein a shape of the aggregate particles is a scale-like shape.

### (Configuration 4)

The resin member according to any one of configurations 1 to 3, wherein an aspect ratio of the aggregate particles is 3 or more and 20 or less.

### (Configuration 5)

The resin member according to any one of configurations 1 to 4, wherein the number of the aggregate particles per unit area is one particle/mm² or more and 100 particles/mm² or less.

### (Configuration 6)

The resin member according to any one of configurations 1 to 5, wherein the particle diameter of the aggregate particles is 5 μm or more.

### (Configuration 7)

The resin member according to any one of configurations 1 to 6, wherein the dielectric particles contain a titanate compound.

### (Configuration 8)

The resin member according to any one of configurations 1 to 7, wherein the dielectric particles contain barium titanate.

### (Configuration 9)

The resin member according to any one of configurations 1 to 8, wherein a contained amount of the dielectric particles is 0.1 mass % or more and 10 mass %.

### (Configuration 10)

The resin member according to any one of configurations 1 to 9, wherein the matrix resin is a thermoplastic resin.

### (Configuration 11)

The resin member according to any one of configurations 1 to 10, wherein the matrix resin contains a polar polymer.

### (Configuration 12)

The resin member according to any one of configurations 1 to 11, wherein the matrix resin contains a crystalline polymer.

### (Configuration 13)

The resin member according to any one of configurations 1 to 12, wherein the matrix resin contains polyester.

### (Configuration 14)

The resin member according to any one of configurations 1 to 13, wherein the matrix resin contains polyethylene terephthalate.

### (Configuration 15)

The resin member according to any one of configurations 1 to 14, wherein the matrix resin contains polyester and carbodiimide.

### (Configuration 16)

The resin member according to any one of configurations 1 to 15, further comprising an elastomer.

### (Configuration 17)

The resin member according to any one of configurations 1 to 16, further comprising filler particles, other than the dielectric particles, having an inorganic material as a main component.

### (Configuration 18)

The resin member according to configuration 17, wherein a relative permittivity of the inorganic material is less than 10.

### (Configuration 19)

The resin member according to any one of configurations 1 to 18, further comprising at least one of a metal material including a transition metal element, a compound material including a transition metal element, a metal material including a representative metal element, and a compound material including a representative metal element that are other than the dielectric particles.

### (Configuration 20)

The resin member according to any one of configurations 1 to 19, wherein a volume of the resin member is 1,000 mm³ or more.

### (Configuration 21)

A resin composition comprising:
a matrix resin and dielectric particles dispersed in the matrix resin,
wherein the dielectric particles are aggregate particles each of which is an aggregate of ferroelectric particles,
wherein a particle diameter of the ferroelectric particles is 10 nm or more and 1,000 nm or less,
wherein a particle diameter of the aggregate particles is 1 μm or more and 100 μm or less, and
wherein the matrix resin contains polyester and carbodiimide.

### (Configuration 22)

A resin composition comprising:
a matrix resin and dielectric particles dispersed in the matrix resin,
wherein the dielectric particles are aggregate particles each of which is an aggregate of paraelectric particles having a relative permittivity of 10 or more,
wherein a particle diameter of the paraelectric particles is 10 nm or more and 1,000 nm or less,
wherein a particle diameter of the aggregate particles is 1 μm or more and 100 μm or less, and wherein the matrix resin contains polyester and carbodiimide.

### (Configuration 23)

A method for manufacturing a resin member, the method comprising:
melting the resin composition according to configuration 21 or 22 and injecting the resin composition into a metal mold.

### (Configuration 24)

An electronic device comprising:
the resin member according to any one of configurations 1 to 20; and
at least one of an electric component, a metal component, and an optical component.

### (Configuration 25)

The electronic device according to configuration 24, wherein the resin member is an exterior body.

The present disclosure is not limited to the above-described embodiments, and various changes and modifications may be made without departing from the spirit and scope of the present disclosure. Accordingly, the following claims are appended to define the scope of the present disclosure.

According to the present disclosure, it is possible to provide a resin member for an electronic device excellent in electrical characteristics.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A resin member for an electronic device, a volume of the resin member being 1,000 mm³ or more, comprising:
a matrix resin and dielectric particles dispersed in the matrix resin,
wherein the dielectric particles are aggregate particles each of which is an aggregate of ferroelectric particles,
wherein a particle diameter of the ferroelectric particles is 10 nm or more and 1,000 nm or less,
wherein a particle diameter of the aggregate particles is 1 μm or more and 100 μm or less, and
wherein a contained amount of the dielectric particles is 0.1 mass % or more and 10 mass % or less.

2. A resin member for an electronic device, a volume of the resin member being 1,000 mm³ or more, comprising:
a matrix resin containing a polar polymer and/or a crystalline polymer and dielectric particles dispersed in the matrix resin,
wherein the dielectric particles are aggregate particles each of which is an aggregate of paraelectric particles having a relative permittivity of 10 or more,
wherein a particle diameter of the paraelectric particles is 10 nm or more and 1,000 nm or less, and
wherein a particle diameter of the aggregate particles is 1 μm or more and 100 μm or less.

3. The resin member according to claim 1, wherein a shape of the aggregate particles is a scale-like shape.

4. The resin member according to claim 1, wherein an aspect ratio of the aggregate particles is 3 or more and 20 or less.

5. The resin member according to claim 1, wherein the number of the aggregate particles per unit area is one particle/mm² or more and 100 particles/mm² or less.

6. The resin member according to claim 1, wherein the particle diameter of the aggregate particles is 5 μm or more.

7. The resin member according to claim 1, wherein the dielectric particles contain barium titanate.

8. The resin member according to claim 2, wherein a contained amount of the dielectric particles is 0.1 mass % or more and 10 mass % or less.

9. The resin member according to claim 1, wherein the matrix resin contains at least one of a thermoplastic resin, a polar polymer, and a crystalline polymer.

10. The resin member according to claim 1, wherein the matrix resin contains at least one of polyester and polyethylene terephthalate.

11. The resin member according to claim 1, wherein the matrix resin contains polyester and carbodiimide.

12. The resin member according to claim 1, further comprising an elastomer.

13. The resin member according to claim 1, further comprising filler particles, other than the dielectric particles, having an inorganic material as a main component.

14. The resin member according to claim 13, wherein a relative permittivity of the inorganic material is less than 10.

15. The resin member according to claim 1, further comprising at least one of a metal material including a transition metal element, a compound material including a transition metal element, a metal material including a representative metal element, and a compound material including a representative metal element that are other than the dielectric particles.

16. A resin composition comprising:
a matrix resin and dielectric particles dispersed in the matrix resin,
wherein the dielectric particles are aggregate particles each of which is an aggregate of ferroelectric particles,
wherein a particle diameter of the ferroelectric particles is 10 nm or more and 1,000 nm or less,
wherein a particle diameter of the aggregate particles is 1 μm or more and 100 μm or less, and
wherein the matrix resin contains polyester and carbodiimide.

17. A resin composition comprising:
a matrix resin and dielectric particles dispersed in the matrix resin,
wherein the dielectric particles are aggregate particles each of which is an aggregate of paraelectric particles having a relative permittivity of 10 or more,
wherein a particle diameter of the paraelectric particles is 10 nm or more and 1,000 nm or less,
wherein a particle diameter of the aggregate particles is 1 μm or more and 100 μm or less, and
wherein the matrix resin contains polyester and carbodiimide.

18. A method for manufacturing a resin member, the method comprising:
melting the resin composition according to claim 16 and injecting the resin composition into a metal mold.

19. An electronic device comprising:
the resin member according to claim 1; and
at least one of an electric component, a metal component, and an optical component.

20. The electronic device according to claim 19, wherein the resin member is an exterior body.
